(19) United States
(12) Patent Application Publication
(10) Pub. No.: US 2009/0191999 A1
(43) Pub. Date: Jul. 30, 2009

(54) Dust Shield For A Pulley Bearing And A Pulley With A Dust Shield

(76) Inventors: Kacy Joseph, Brampton (CA); John R. Antchak, Aurora (CA); Gerald J. Hamers, Woodbridge (CA); Gary J. Spicer, Mississauga (CA)

Correspondence Address: MAGNA INTERNATIONAL, INC., 337 MAGNA DRIVE, AURORA, ON, L4G-7K1, CA

(21) Appl. No.: 12/302,332

(22) PCT Filed: May 31, 2007
(86) PCT No.: PCT/CA2007/000974

§ 371 Date: Nov. 25, 2008

Related U.S. Application Data
(60) Provisional application No. 60/809,871, filed on Jun. 1, 2006.

(51) Int. Cl. F16H 55/36; F16C 33/76

(52) U.S. Cl. 474/199; 384/485

(57) ABSTRACT

A dust shield to inhibit the ingress of foreign materials into a pulley bearing is disclosed as is a pulley including such a dust shield. The dust shield is press fit to one side of the bearing such that it is captive during assembly and/or installation of the pulley. A second dust shield can be provided on the opposite side of the bearing to further inhibit the ingress of foreign materials. Preferably, at least one of the dust shields includes a bolt retention feature which holds an installation bolt captive to the pulley prior to installation. The dust shields can be fabricated from selected materials with desired thermal characteristics to insulate the bearing from sources of undesired heat and/or to assist the removal of waste heat from the bearing.

### FIELD OF THE INVENTION

The present invention relates to a dust shield for a bearing and to a pulley with a bearing with a dust shield. More specifically, the present invention relates to a dust shield to prevent the ingress of foreign materials into the bearing of a pulley and to a pulley equipped with a dust shield.

### BACKGROUND OF THE INVENTION

Flexible drives, in particular belt-driven accessory drives in vehicular engine compartments, typically include one or more tensioners or idlers which include pulleys that contact the drive. Due to the rotational speed of these pulleys and the loads they carry, the pulleys typically rotate on bearings, such as roller or ball bearing races, to carry their loads, reduce frictional losses and to reduce operating noise.

While the use of such bearings is widespread and generally satisfactory, vehicular engine compartments and other environments are exposed to a variety of foreign materials such as dirt and water. As a result, the bearings in the flexible drive pulleys can suffer from the ingress of the foreign materials into their bearing surfaces. Such ingress can increase the friction in the bearing and/or can abrade the bearing surfaces reducing the operating lifetime of the bearing. While many bearings include seals to inhibit the ingress of foreign materials, such seals are not perfect and degrade over time, leading to the ingress of foreign material and ultimately failure of the bearings.

Previous attempts to reduce the ingress of foreign materials have consisted of the provision of oversized washers on the mounting bolt attaching the pulley to its mounting surface, the washers being located on one or both sides of the bearing to act as a physical barrier between the bearing and foreign materials.

While such washers can reduce the ingress of foreign materials into the bearing, they are not fully effective as they merely abut the bearing and foreign material, in particular water and water-borne particles, can infiltrate behind the edges of the washer and into the bearing. Further, the provision of the washers requires additional assembly/installation steps when assembling or installing the pulley, increasing the assembly/installation expense. Further, washers can be inadvertently omitted from assembly/installation, resulting in increased expenses for defective parts and/or premature failure of a pulley installed without a washer.

### SUMMARY OF THE INVENTION

It is an object of the present invention to provide a novel dust shield for a pulley bearing which obviates or mitigates at least one disadvantage of the prior art. It is a further object of the present invention to provide a novel pulley with a dust shield which obviates or mitigates at least one disadvantage of the prior art.

According to a first aspect of the present invention, there is provided a dust shield to inhibit the ingress of foreign materials into a pulley bearing and a pulley. The dust shield is press fit to one side of the bearing such that it is captive during assembly and/or installation of the pulley. A second dust shield can be provided on the opposite side of the bearing to further inhibit the ingress of foreign materials. Preferably, at least one of the dust shields includes a bolt retention feature which holds an installation bolt captive to the pulley prior to installation. The dust shields can be fabricated from selected materials with desired thermal characteristics to insulate the bearing from sources of undesired heat and/or to assist the removal of waste heat from the bearing.

### BRIEF DESCRIPTION OF THE DRAWINGS

Preferred embodiments of the present invention will now be described, by way of example only, with reference to the attached Figures, wherein:

FIG. 1 shows a side section through a pulley in accordance with the present invention;

FIG. 2 shows an exploded perspective view of the section of FIG. 1;

FIG. 3 shows a side perspective view of a dust shield in accordance with the present invention;

FIG. 4 shows a top view of the dust shield of FIG. 3;

FIG. 5 shows a side perspective view of another dust shield in accordance with the present invention;

FIG. 6 shows a side section though a pulley in accordance with a second embodiment of the present invention; and

FIG. 7 shows a side section through a pulley in accordance with a third embodiment of the present invention.

### DETAILED DESCRIPTION OF THE INVENTION

As used herein, the term dust shield is intended to comprise a barrier member which inhibits the ingress of foreign materials such as water, water-borne particles or dry particulate materials into a bearing.

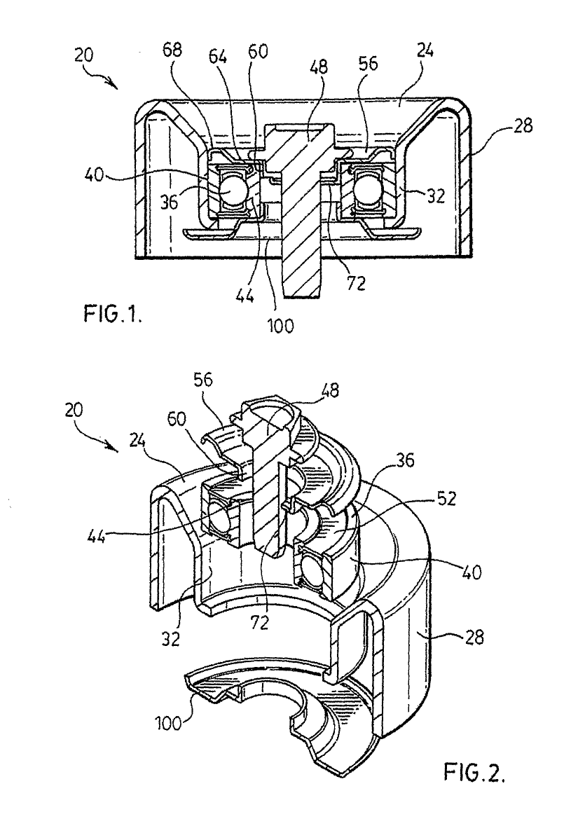

FIG. 1 shows a pulley 20 in accordance with the present invention. Pulley 20 can be used in a variety of ways including as an idler for a flexible drive on an internal combustion engine or as a pulley in a tensioner for a flexible drive means.

Pulley 20 includes a pulley member 24 which includes a cylindrical outer surface 28 configured to engage the flexible drive means and further includes a centered cup-shaped raceway 32 to receive a bearing 36. Bearing 36 can be any suitable bearing, such as a roller bearing assembly or ball bearing assembly having an outer race 40 which frictionally engages pulley member 24 and an inner race 44 which receives a bolt 48 that mounts pulley 20 to the surface or member on which it is installed. A series of ball bearings are interposed between the outer race 40 and the inner race 44, as is well known in the art. Bearing 36 defines an axis of rotation about which the pulley 20 rotates.

As best seen in FIG. 2, bearing 36 preferably includes a resilient seal 52 on each side which is intended to inhibit the ingress of foreign materials into the interior of bearing 36. However, due to the rotation of outer race 40 about inner race 44 resilient seal 52 is not capable of preventing the ingress of all foreign materials into the interior of bearing 36. Further, over time resilient seal 52 can be subject to thermal cycling between relatively high operating temperatures and colder ambient temperatures and the resulting thermal and age-based degradation of the material of resilient seal 52 results in a significant decline in the effectiveness of resilient seal 52.

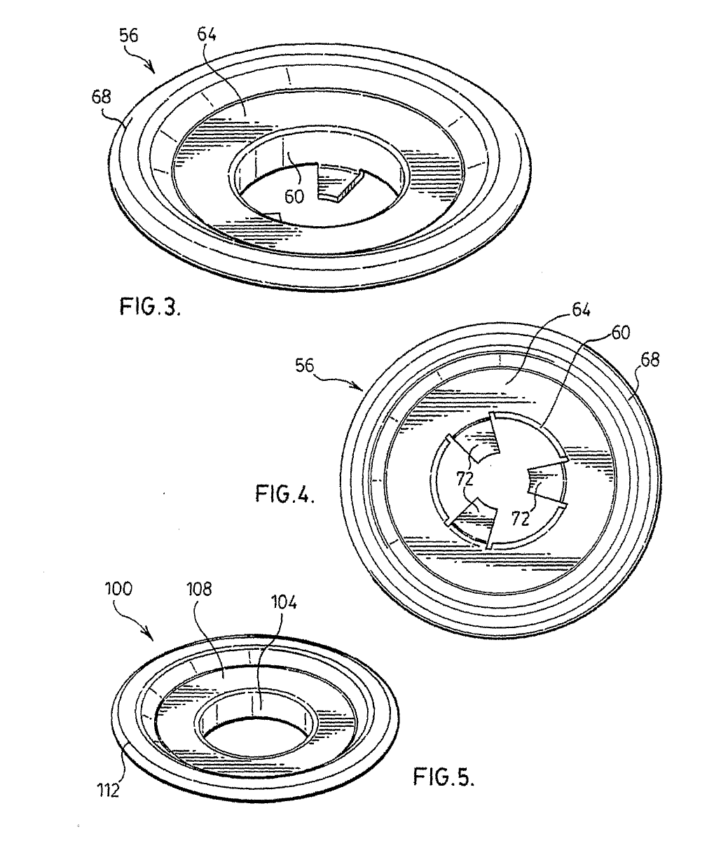

In the present invention, a dust shield 56, best seen in FIG. 3, is provided to augment or replace the function of resilient shield 52 to inhibit the ingress of foreign materials into the interior of bearing 36.

Unlike prior art washers that were employed as dust shields in front of bearings, dust shield 56 includes an inner axial lip 60 whose outer diameter, in combination with the thickness (gauge) of the material from which dust shield 56 is formed, allows dust shield 56 to be press fit into the inner radial surface of inner race 44 of bearing 36 such that the resulting interference fit retains dust shield 56 in position on bearing 36, as shown in FIG. 1.

As is best seen in FIG. 3, dust shield 56 includes a generally planar annular portion 64 which overlies and protects a portion of resilient seal 52 when dust shield 56 is installed on bearing 36. Dust shield 56 further includes a raised outer lip 68 which extends radially outwardly over the remainder of resilient seal 52 and bearing 36 and to closely approach raceway 32 of pulley member 24. Outer lip 68 is positioned as close as tolerances allow to be close to but not in engagement with the pulley member 24.

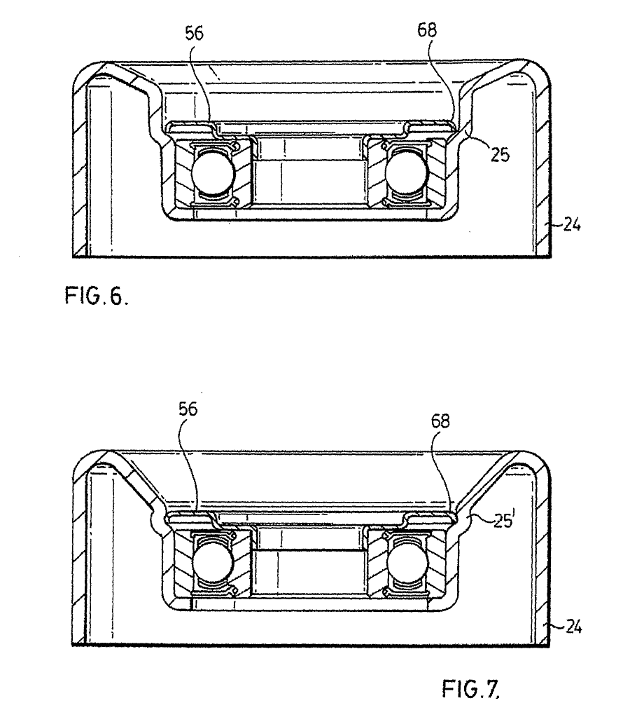

Optionally as shown in FIGS. 6 and 7, the pulley member 24 can be configured with a circumferentially extending groove 25 and 25′ that the outer lip 68 extends into but again the outer lip 68 does not engage the pulley member 24 presenting a serpentine or labyrinth path between the pulley member 24 and the dust shield 56. The serpentine or labyrinth path minimizes the likelihood of water and dirt migration into the bearing 36.

As should now be apparent, when press fit to bearing 36, dust shield 56 is held captive in this position and acts as a barrier to inhibit the ingress of foreign material into the interior of bearing 36. By being held captive to bearing 36, the inadvertent omission of dust shield 56 during assembly and/or installation of pulley 20 is prevented.

In a present embodiment of the invention, dust shield 56 is formed by stamping galvanized steel, approximately 0.58 mm in thickness, and the exposed outer and inner radial edges of dust shield 56 are preferably treated with an anti-corrosion coating. However, as will be apparent to those of skill in the art, dust shield 56 can be fabricated from a variety of other materials, including zinc, tin, other metal alloys or suitable plastic materials.

An additional contemplated advantage of dust shield 56 being fabricated from metal is the enhanced removal of waste heat from bearing 36. In operation, pulley member 24 can rotate at high speeds and be subject to significant loads which result in a significant amount of heat being generated within bearing 36. As the operating lifetime of bearing 36 is adversely affected by operation at high temperature levels, it is generally desired that as much waste heat be removed from bearing 36 as reasonably possible.

However, for cost reasons, pulley member 24 is often fabricated from materials, such as plastics, which do not assist in dissipating the waste heat produced in bearing 36. Even when pulley member 24 is fabricated from metal, it can still be difficult to remove desired amounts of waste heat from bearing 36.

By employing dust shield 56 which is fabricated from a material with reasonably good thermal transfer characteristics, such as the above-mentioned galvanized steel, an additional surface is provided over which the transfer of the waste heat from bearing 36 to the surrounding atmosphere can occur.

Further, whether metal or plastic, it is contemplated that dust shield 56 can be treated to enhance its thermal transfer capabilities, if desired. For example, a coating, such as the thermal dispersant coating sold by Tech Line Coatings, Inc. of Murrieta Calif. under the brand name TLTD, can be applied to dust shield 56 to enhance its thermal transfer capabilities thus enhancing the removal of waste heat from bearing 36.

While not necessary, it is preferred that dust shield 56 further include a bolt retention feature. As best seen in FIG. 4, in a present embodiment dust shield 56 includes at least two, and in the illustrated embodiment three, radially inwardly extending tabs 72. When dust shield 56 is formed, tabs 72 extend radially inwardly to sufficient extent such that, when bolt 48 is inserted into dust shield 56, tabs 72 deform while engaging the radially outer circumferential surface of bolt 48 to retain bolt 48 in place.

In this manner, dust shield 56 is captive to bearing 36 and bolt 48 is captive to dust shield 56 and pulley 20 can be assembled into the configuration illustrated in FIGS. 1 and 2 with bolt 48 captive and ready for installation of pulley 20, thus simplifying installation of pulley 20 onto an engine, tensioner or other component.

Tabs 72 of the bolt retention feature can accommodate bolts 48 of different sizes, without modification, should an embodiment of pulley 20 be used with different sized bolts. For example, if a single embodiment of pulley 20 is installed on different engines, pulleys 20 for installation on one engine will have the appropriate sized bolts, e.g. M6, inserted into dust shield 56 while pulleys 20 for a different engine will have the appropriate sized bolts, e.g. M8, inserted into dust shield 56.

Similarly, it is contemplated that a single dust shield 56 design and/or size can be used with different embodiments of pulley 20, provided that the inner radial and outer radial dimensions of bearing 36 are similar in each embodiment.

Depending upon where pulley 20 is installed, foreign material may still be able to reach the interior of bearing 36 from the back (the lower side in the orientation illustrated in FIGS. 1 and 2) of pulley 20. In such cases, a second dust shield 100 can be provided to inhibit the ingress of foreign materials via such a route, as shown in FIGS. 1 and 2.

Dust shield 100, which is best seen in FIG. 5, includes an inner lip 104, which is similar to inner lip 60, and whose diameter, in combination with the thickness (gauge) of the material from which dust shield 100 is formed, allows inner lip 104 to be press fit into the inner radial surface of inner surface 44 of bearing 36 such that the resulting interference fit allows dust shield 100 to be retained in position on bearing 36, as shown in FIG. 1.

Dust shield 100 further includes a generally planar annular portion 108 which overlies and protects a portion of resilient seal 52 on the back of bearing 36 when dust shield 104 is installed on bearing 36 and further includes a raised outer lip 112 which extends radially outwardly over the remainder of resilient seal 52 and bearing 36 and extends over the outer radial edge of raceway 32, presenting a serpentine or labyrinth path between the pulley member 24 and the dust shield 100.

As should now be apparent, when press fit to bearing 36, dust shield 56 is held captive in this position and acts to inhibit the ingress of foreign material into the interior of bearing 36. By being held captive to bearing 36, the inadvertent omission of dust shield 56 during assembly and/or installation of pulley 20 is also prevented.

In a present embodiment of the invention, dust shield 100 is stamped from the same material as dust shield 56, although it is contemplated that dust shield 100 can be fabricated from a different material than dust shield 56 if desired.

As with dust shield 54, dust shield 100 can also assist in managing the thermal operating conditions of bearing 36. For example, if dust shield 100 is fabricated from a material with good thermal transfer characteristics, such as the above-mentioned galvanized steel, dust shield 100 can serve as another surface over which waste heat from bearing 36 can be transferred to the surrounding air. If desired, the above mentioned thermal dispersant coating or the like can also be applied to dust shield 100.

However it is also contemplated that, in many circumstances, pulley 20 will be installed on a surface or object, such as an internal combustion engine, which itself produces heat which could be transferred to bearing 36. In such a case, dust shield 100 can act to insulate bearing 36 from this source of undesired heat by fabricating dust shield 100 from a material with relatively good thermal insulating properties and/or by applying a thermal barrier coating, such as the thermal barrier coating sold by Tech Line Coatings, Inc. of Murrieta Calif. under the brand name TLLB. In such a case, the combination of a thermally insulating dust shield 100, between the source of undesired heat, and thermally conductive dust shield 56, providing a surface from which waste heat from bearing 36 can be radiated, can provide a thermal management system for bearing 36.

While in the illustrated embodiment bolt 48 is shown as being installed extending from front (the upper surface in the orientation illustrated in FIG. 1) to back (the lower surface in the orientation illustrated in FIG. 1) of pulley 20, as will be apparent to those of skill in the art in some circumstances it may be desired to have bolt 48 extend from the back of pulley 20 to the front. In such a case, dust shield 100 can be provided with a bolt retention feature, such as tabs 72 of dust shield 56, while dust shield 56 can omit such a feature. Further, as should also be apparent to those of skill in the art, depending upon the orientation of how pulley 20 is to be installed, it can be desired to have dust shield 56 fabricated from a thermally insulating material and dust shield 100 fabricated from a thermally transmissive material and/or corresponding thermal coatings applied to the respective dust shields 56 and 100.

The present invention provides a dust shield to inhibit the ingress of foreign materials into a pulley bearing. The dust shield is press fit to one side of the bearing such that it is captive during assembly and/or installation of the pulley. A second dust shield can be provided on the opposite side of the bearing to further inhibit the ingress of foreign materials. Preferably, at least one of the dust shields includes a bolt retention feature which holds an installation bolt captive to the pulley prior to installation. The dust shields can be fabricated from selected materials with desired thermal characteristics to insulate the bearing from sources of undesired heat and/or to assist the removal of waste heat from the bearing.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A dust shield for inhibiting the ingress of foreign materials into a bearing of a pulley, the dust shield being an annular member comprising:
a generally planar annular portion, said annular portion sized to cover at least a portion of a face of a bearing;
an inner lip extending axially from the annular portion and being sized to engage an inner radial surface of an inner race of a bearing to form an interference fit therewith;
an outer lip extending from the annular portion to substantially cover a remainder of the face of a bearing, wherein the interference fit retains the dust shield in place on a bearing.

2. The dust shield of claim 1 wherein the inner lip is sized to be press fit to the bearing to form the interference fit.

3. The dust shield of claim 1 wherein the dust shield is formed from a material with thermal transmission characteristics to assist in a transfer of heat from the bearing.

4. The dust shield of claim 1 wherein the dust shield is formed from a material with thermal insulating characteristics to inhibit the transfer of heat to the bearing.

5. The dust shield of claim 1 further including a bolt retention feature operable to maintain a mounting bolt radially captive to the dust shield.

6. The dust shield of claim 1 wherein a coating is applied to the dust shield to alter its thermal transfer characteristics.

7. The dust shield of claim 6 wherein the coating enhances the transfer of heat to and from the dust shield.

8. The dust shield of claim 6 wherein the coating inhibits the transfer of heat to and from the dust shield.

9. A pulley, comprising:
a pulley member having a substantially cylindrical outer surface to engage a flexible drive means and a centered raceway;
a bearing mounted in said centered raceway, said bearing defining an axis of rotation about which said pulley rotates; and
a dust shield including an inner lip press fit into a center portion of the bearing to produce an interference fit holding the dust shield captive to a first face of the bearing, the dust shield inhibiting the ingress of foreign material into the bearing.

10. The pulley of claim 9 further including a bolt retention feature configured to retain a mounting bolt captive to the dust shield.

11. The pulley of claim 10 wherein the bolt retention feature comprises at least two tabs extending radially inwardly from the inner lip.

12. The pulley of claim 9 further comprising a second dust shield including an inner lip press fit into the center portion of the bearing to produce an interference fit holding the second dust shield captive to a second face of the bearing, the second dust shield inhibiting the ingress of foreign material into the bearing.

13. The pulley of claim 12 further including a bolt retention feature to retain a mounting bolt captive to at least one of the dust shield and second dust shield.

14. The pulley of claim 13 wherein the bolt retention feature comprises at least two tabs extending radially inwardly from at least one of the inner lips of at least one of the dust shield and second dust shield.

15. The pulley of claim 9 wherein the dust shield is fabricated from a material selected to assist in a transfer of heat from the bearing.

16. The pulley of claim 12 wherein the dust shield is fabricated from a material selected to assist in transfer of heat from the bearing and the second dust shield is fabricated from a material selected to inhibit transfer of heat to the bearing.

17. The pulley of claim 9 wherein said dust shield has an outer lip that closely approaches but does not engage with the pulley member.

18. The pulley of claim 17 wherein said pulley member is configured to cooperate with said outer lip to present a serpentine path therebetween.
